(19) United States
(12) Patent Application Publication
(10) Pub. No.: US 2015/0131577 A1
(43) Pub. Date: May 14, 2015

(54) COOPERATION TRANSMISSION METHOD, TERMINAL AND BASE STATION SUPPORTING THE SAME

(71) Applicant: ELECTRONICS AND TELECOMMUNICATIONS RESEARCH INSTITUTE, Daejeon (KR)

(72) Inventors: Eunkyung KIM, Daejeon (KR); Jae Sun CHA, Daejeon (KR); Jae Joon PARK, Daejeon (KR); Hyun LEE, Daejeon (KR); Kwang Jae LIM, Daejeon (KR); Sung Cheol CHANG, Daejeon (KR)

(73) Assignee: ELECTRONICS AND TELECOMMUNICATIONS RESEARCH INSTITUTE, Daejeon (KR)

(21) Appl. No.: 14/535,676

(22) Filed: Nov. 7, 2014

(30) Foreign Application Priority Data
Nov. 8, 2013 (KR) 10-2013-0135833
Nov. 7, 2014 (KR) 10-2014-0154153

(51) Int. Cl. H04B 7/02; H04W 72/04; H04W 24/02

(52) U.S. Cl. CPC H04B 7/024; H04W 24/02; H04W 72/0426
USPC 370/329

(57) ABSTRACT

A method of providing cooperative communication to a terminal through a plurality of base stations is provided. A plurality of base stations each transmit a midamble to a terminal, and the terminal measures a channel through a received midamble. The terminal transmits information about the measured channel to at least one of the plurality of base stations.

### CROSS-REFERENCE TO RELATED APPLICATION

This application claims priority to and the benefit of Korean Patent Application Nos. 10-2013-0135833 and 10-2014-0154153 filed in the Korean Intellectual Property Office on Nov. 8, 2013 and Nov. 7, 2014, respectively, the entire contents of which are incorporated herein by reference.

### BACKGROUND OF THE INVENTION

(a) Field of the Invention

The present invention relates to a cooperative transmission method, and a terminal and a base station that support the same.

(b) Description of the Related Art

A terminal that is located at a cell boundary may receive interference from a neighboring cell or may provide interference to a neighboring cell, and network performance may be deteriorated due to such interference. By controlling interference occurring in such a cell boundary region, network performance can be improved.

A method of controlling interference of a cell boundary region may include a resource management method for interference control or a cooperative transmission method for interference control. A cooperative transmission method for interference control is a method of improving performance of a terminal that is located at a cell boundary or a terminal that receives interference by enabling neighboring base stations to cooperate. Such a cooperative transmission method is performed through cooperation between base stations. Particularly, in various forms of cells that are formed through a small base station and a multilayer network in which a macro base station and a small base station are overlapped, a method of efficiently performing cooperative transmission is requested.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an efficient cooperative transmission method.

The present invention has been made in a further effort to provide a method of measuring and reporting a channel state between a base station and a terminal, when performing cooperative transmission.

An exemplary embodiment of the present invention provides a method in which a terminal receives a service through cooperative communication between a first base station and a second base station. The method includes: receiving a first midamble from the first base station; receiving a second midamble from the second base station; measuring a channel through the first midamble and the second midamble; and transmitting information about the measured channel to the first base station.

The method may further include receiving a channel measurement request message, which is a message that requests measurement of the channel, wherein the channel measurement request message may include information about a location of the first midamble and the second midamble.

The first midamble and the second midamble may be received at different time points.

The first midamble and the second midamble may be received at the same time point and may include different identifiers.

The first and second midambles may each be a plurality of midambles, and the transmission of information about the measured channel may include transmitting the information corresponding to some midambles of the plurality of midambles to the first base station.

The method may further include transmitting the measured channel information to the second base station.

The method may further include receiving downlink data from the first base station and the second base station.

The first base station may select a transmission method of improving a service of the terminal, and the second base station may select a transmission method of reducing or removing interference to the first terminal.

The channel measurement request message may further include cell ID and a terminal feedback type.

Another embodiment of the present invention provides a method in which a first base station provides a service to a terminal by cooperating with a second base station. The method include: transmitting a channel estimation request message based on sounding to the terminal; receiving a sounding signal from the terminal; estimating a downlink channel by measuring the sounding signal; and performing cooperative transmission with the terminal to correspond to the estimated downlink channel.

The method may further include: transmitting information about the estimated downlink channel to a coordinator; and receiving a request for the cooperative transmission from the coordinator; and responding to the request from the coordinator.

The channel estimation request message may include information about a resource that is used for transmitting the sounding signal, and the second base station may use the resource for overhearing the sounding signal.

The second base station may estimate a downlink channel by overhearing the sounding signal through the resource.

The second base station may perform cooperative transmission to the terminal to correspond to the estimated downlink channel.

The second base station may perform beamforming that reduces interference to the terminal or perform interference cancellation or interference nulling on the terminal to correspond to the estimated downlink channel.

Yet another embodiment of the present invention provides a terminal that receives a service through cooperative communication between/among a plurality of base stations. The terminal includes: a radio frequency (RF) module that receives a plurality of midambles from the plurality of base stations; and a processor that controls to measure a channel through the plurality of midambles and to transmit information about the measured channel to at least one of the plurality of base stations.

The plurality of base stations may include a first base station and a second base station, and a first midamble that is received from the first base station and a second midamble that is received from the second base station may be received at different time points.

The processor may control to transmit the information corresponding to some midambles of the plurality of midambles to the at least one base station.

The RF module may receive a channel measurement request message, which is a message that requests measurement of the channel, and the channel measurement request message may include information about a location of the plurality of midambles signals.

### BRIEF DESCRIPTION OF THE DRAWINGS

FIG. 1 is a diagram illustrating a concept of a cooperative transmission method according to an exemplary embodiment of the present invention.

FIG. 2 is a flowchart illustrating a cooperative transmission method according to an exemplary embodiment of the present invention.

FIG. 3 is a flowchart illustrating a method of estimating a channel based on sounding according to an exemplary embodiment of the present invention.

FIG. 4 is a flowchart illustrating a method of estimating a channel through a midamble according to an exemplary embodiment of the present invention.

FIG. 5 is a diagram illustrating a case in which a plurality of base stations transmit the same midamble at different time points.

FIG. 6 is a diagram illustrating a case in which a plurality of base stations transmit a midamble at the same time point.

FIG. 7 is a diagram illustrating a serving base station according to an exemplary embodiment of the present invention.

FIG. 8 is a diagram illustrating a terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a terminal may indicate a mobile terminal (MT), a mobile station (MS), an advanced mobile station (AMS), a high reliability mobile station (HR-MS), a subscriber station (SS), a portable subscriber station (PSS), an access terminal (AT), and a user equipment (UE) and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B (NodeB), an evolved node B (eNodeB), an access point (AP), a radio access station (RAS), a base transceiver station (BTS), a mobile multihop relay (MMR)-BS, a relay station (RS) that performs a function of the BS, and an HR-RS that performs a function of the BS, and may include an entire function or a partial function of the BS, the ABS, the HR-BS, the NodeB, the eNodeB, the AP, the RAS, the BTS, the MMR-BS, the RS, and the HR-RS.

Hereinafter, a cooperative transmission method, and a terminal and a BS that support the same, will be described in detail with reference to the drawings.

An entire system for cooperative transmission includes a BS, a terminal, and a coordinator. A BS and a terminal exchange data through wireless communication, and in order to control interference, a coordinator may directly manage or control the terminal or may indirectly manage or control the terminal through the BS. Here, the coordinator may exist within the BS, and may separately exist as a device independent of the BS.

In the following description, for convenience, a case in which a coordinator is a separate independent device will be exemplified. For convenience of description, a downlink service of a BS and a terminal is described, but an uplink service may be applied with the same method or a similar method.

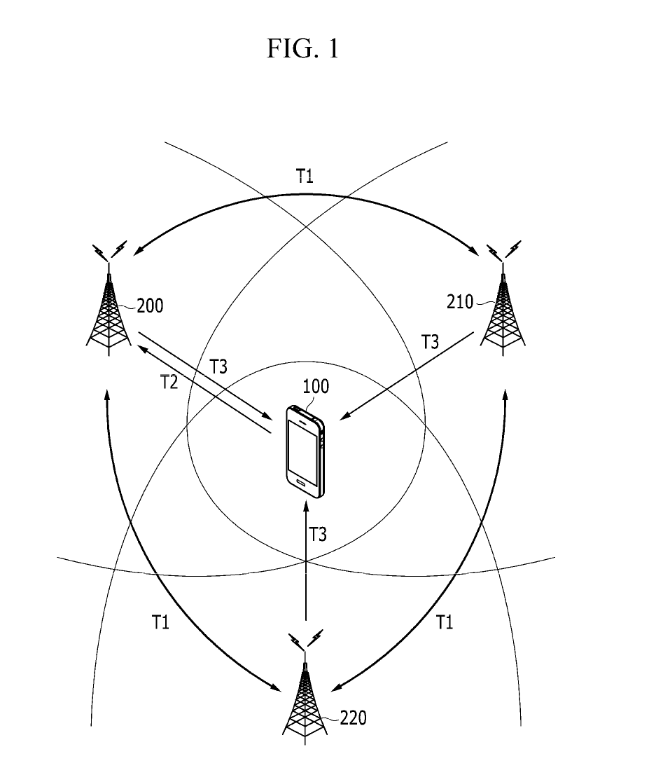

FIG. 1 is a diagram illustrating a concept of a cooperative transmission method according to an exemplary embodiment of the present invention.

In FIG. 1, a terminal 100 is included in a cell of a serving BS 200 and is located at a cell boundary. Neighboring BSs 210 and 220 are adjacent to the BS 200. The BSs 200, 210, and 220 that can perform cooperative transmission simultaneously provide a service to the terminal 100, thereby improving a Quality of Service (QoS).

Here, the BSs 200, 210, and 220 that can perform cooperative transmission may be managed in a group (or a set). Specifically, the BSs 200, 210, and 220 cooperate with each other (T1). The terminal 100 measures a channel state and reports a measurement result to the serving BS 200 (T2). The serving BS 200 and the neighboring BSs 210 and 220 perform cooperative transmission that simultaneously transmits data to a terminal 100 (T3). When performing cooperative transmission, only a BS or some BSs of the plurality of BSs 200, 210, and 220 may be set to transmit data to the terminal 100, and the remaining BSs not may be set to transmit data. Interference can be reduced through such cooperative transmission.

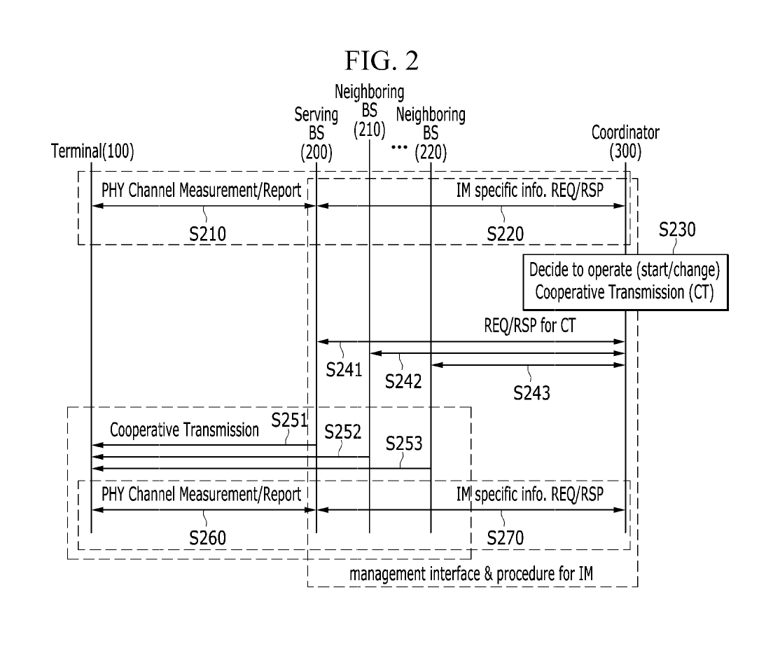

FIG. 2 is a flowchart illustrating a cooperative transmission method according to an exemplary embodiment of the present invention. Specifically, FIG. 2 illustrates a management interface and procedure for interference management (IM). A coordinator is designated by reference numeral 300, and the coordinator 300 may be a Network Control Management System (NCMS).

The terminal 100 measures a channel state (e.g., a Signal to Interference-plus-Noise Ratio (SINR) or a Carrier to Interference-plus-Noise Ratio (CINR)) for wireless communication and reports a measurement result to the serving BS 200 (S210). Here, the channel state may include information on interference caused by the neighboring BSs 210 and 220.

The serving BS 200, having received the report of a channel state, reports the channel state to the coordinator 300 for interference control (S220). Specifically, the serving BS 200 may report to the coordinator 300 when a channel state is a threshold value or less, periodically, whenever receiving a report of a channel state from the terminal 100, or when receiving a report request from the coordinator 300. The serving BS 200 may report only a channel state of a BS that can perform cooperative transmission to the coordinator 300, or may report only a channel state of a BS that can perform performance improvement (of a network or a terminal) through cooperative transmission. Alternatively, because the coordinator 300 selects a BS for cooperative transmission and selects an antenna, the serving BS 200 may simply report only a channel state result to the coordinator. In this case, the coordinator 300 may select some or all BSs corresponding to a received channel state report. The coordinator 300 may select a cooperative transmission mode (method).

The coordinator 300, having received a report of a channel state result from at least one BS 200, determines whether to perform cooperative transmission according to a channel state of each BS (S230). Specifically, the coordinator 300 may receive a report of a channel state from other BSs 210 and 220 that the coordinator 300 manages as well as the serving BS 200. If cooperative transmission (e.g., the start of cooperative transmission or a change of cooperative transmission) is necessary, the coordinator 300 requests cooperative transmission of the neighboring BSs 210 and 220 and the BS 200, having reported a channel state result according to a cooperative transmission mode (method) (S241-S243). The coordinator 300 may request cooperative transmission from some or all BSs that are included in a channel state result report. The BSs 200-220 transmit a message in response to a cooperative transmission request to the coordinator 300 (S241-S243). The coordinator 300 may change existing cooperative transmission for cooperative transmission, and if cooperative transmission is no longer necessary, the coordinator 300 may terminate the cooperative transmission. Further, the coordinator 300 may enable a new BS to start cooperative transmission.

Before the BSs 200-220 provide a service to the terminal 100, the coordinator 300 may set only some of the BSs to provide a service using a corresponding resource (a resource that is set by resource management for interference control) and set the remaining BSs to not use a corresponding resource.

The BSs 200-220, having received the request for cooperative transmission, perform cooperative transmission (S251-S253). Specifically, the BSs 200-220 may simultaneously provide a service to the terminal 100 using a preset corresponding resource. That is, the BSs 200-220 may simultaneously transmit the same data to the terminal 100.

The terminal 100 may measure a channel state of a source that receives a service and report the channel state to the serving BS 200 (S260).

The serving BS 200 may report a received channel state report to the coordinator 300 (S270). Thereafter, the coordinator 300 may reset or terminate the cooperative transmission method through the above-described process (S230, S241-S243).

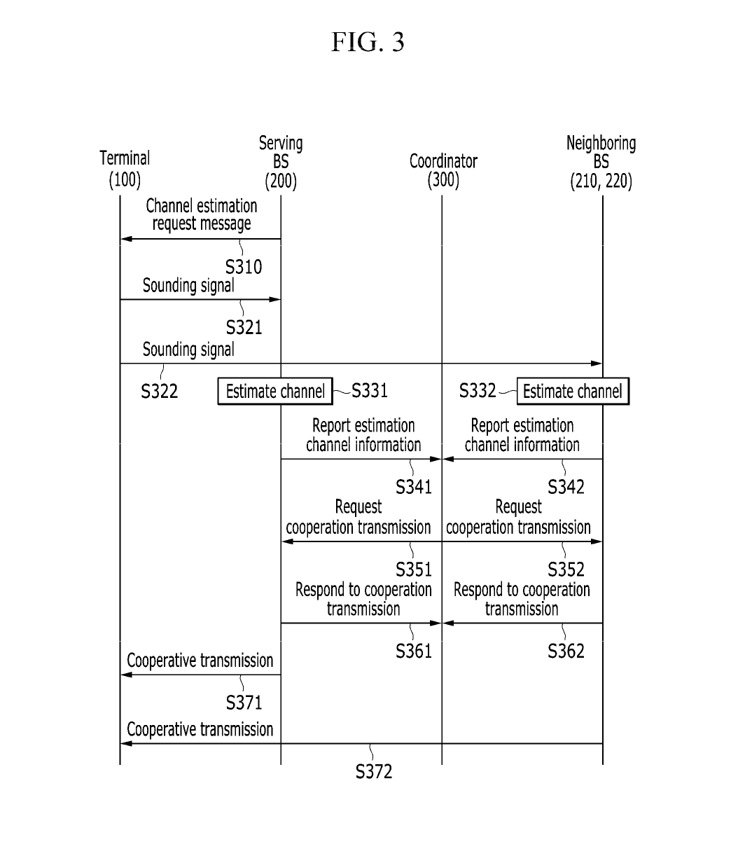

Hereinafter, a method of performing and reporting channel measurement for cooperative transmission according to an exemplary embodiment of the present invention will be described in detail with reference to FIGS. 3 to 6.

FIG. 3 is a diagram illustrating a method of estimating a channel based on sounding according to an exemplary embodiment of the present invention.

Whether to support sounding may be exchanged by a negotiation with the serving BS 200 when the terminal 100 initially accesses to the serving BS 200. Hereinafter, it is assumed that the terminal 100 is a terminal that can perform sounding-based channel estimation.

First, the serving BS 200 transmits a channel estimation request message based on sounding to the terminal 100 (S310). That is, the serving BS 200 may request the terminal 100 that supports uplink sounding to transmit a sounding signal. The channel estimation request message includes resource information that is used for transmitting a sounding signal, and may be a Sounding Command Information Element (Sounding CMD IE) message. The neighboring BSs 210 and 220 to perform cooperative transmission may not use a corresponding resource (a resource for sounding estimation) for objects other than sounding. When the neighboring BSs 210 and 220 estimate a sounding-based downlink channel, the neighboring BSs 210 and 220 may estimate a channel together with the serving BS 200.

The terminal 100, having received the sounding estimation request message transmits a sounding signal to the serving BS 200 (S321). In this case, the sounding signal may also be transmitted to the neighboring BSs 210 and 220 (S322). Here, the terminal 100 transmits a sounding signal using a corresponding resource that is included in the channel estimation request message.

The serving BS 200, having received the sounding signal that is transmitted by the terminal 100, measures the sounding signal and estimates a downlink channel based on the measured channel state information (S331). The neighboring BSs 210 and 220 may overhear a sounding signal in a sounding area that is allocated to the terminal 100 and estimate a downlink channel (S332).

Thereafter, the serving BS 200 reports estimation channel information to the coordinator 300 (S341). The neighboring BSs 210 and 220 may report estimation channel information to the coordinator 300 (S342). In this case, the coordinator 300 may control cooperative transmission appropriate for downlink data transmission based on estimation channel information that is received from the serving BS 200 or the neighboring BSs 210 and 220.

Interference control through a sounding-based channel estimation method may be performed without the coordinator 300. In this case, the serving BS 200 uses estimated channel information, and the neighboring BSs 210 and 220 may perform cooperative transmission in which each BS can independently reduce interference using overheard channel information.

When it is determined that cooperative transmission is necessary through the estimation channel information report, the coordinator 300 requests cooperative transmission from the serving BS 200 (S351). In this case, the coordinator 300 may request cooperative transmission from the neighboring BSs 210 and 220 (S352).

The serving BS 200 or the neighboring BSs 210 and 220, having received the cooperation request, transmit a response message to the coordinator 300 (S361 and S362). The response message includes information about whether a cooperation request is allowed.

Finally, the serving BS 200 and the neighboring BSs 210 and 220 perform cooperative transmission (S371 and S372). That is, the serving BS 200 and the neighboring BSs 210 and 220 simultaneously provide a service (downlink data) to the terminal 100.

Unlike S371 and S372 of FIG. 3, the neighboring BSs 210 and 220 may perform cooperative transmission by controlling a terminal belonging to a cell thereof instead of transmitting downlink data to the terminal 100. That is, when the neighboring BSs 210 and 220 overhear a sounding signal from the terminal 100, the neighboring BSs 210 and 220 may select and service a transmission method (e.g., precoding for multiple antenna transmission) of a terminal belonging to a cell thereof based on the received sounding signal. Further, the neighboring BSs 210 and 220 may perform beamforming and interference cancellation or interference nulling that reduces interference to the terminal 100.

For more efficient interference removal, a BS (a serving BS or a neighboring BS), having received a sounding signal for cooperative transmission may determine a cooperative transmission method based on channel environment information advantageous to a terminal belonging to a cell thereof and bad channel environment information due to interference. For this reason, BSs that perform cooperative communication each determine a cooperative communication method based on channel state information that is received from a terminal belonging to a cell thereof in addition to a cooperative method based on a sounding signal.

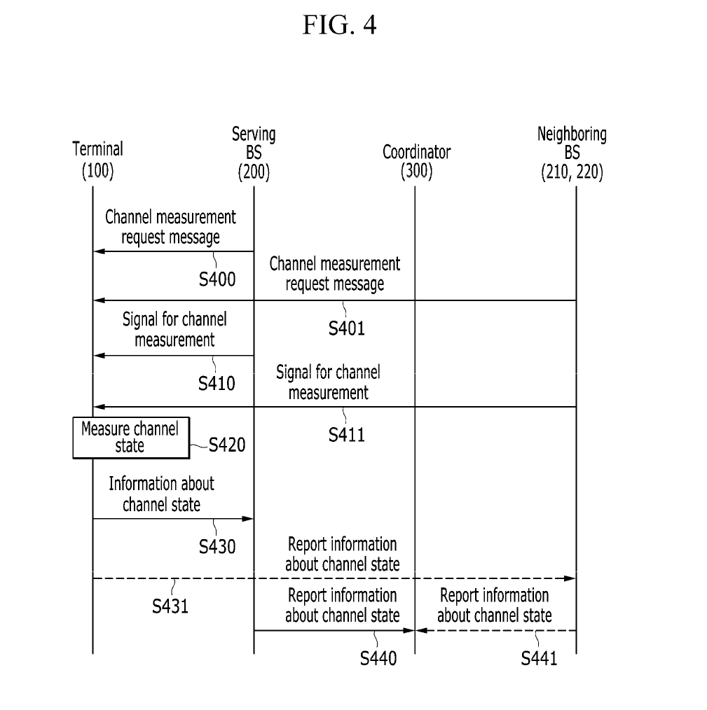

Hereinafter, a method of estimating a channel through a midamble according to an exemplary embodiment of the present invention will be described with reference to FIGS. 4 to 6. That is, a method in which the transmitting side (e.g., a BS) transmits a signal for channel measurement and in which the receiving side (e.g., a terminal) measures and reports a channel will be described. The midamble is a physical channel used for channel measurement when a BS uses a multiple antenna.

FIG. 4 is a flowchart illustrating a method of estimating a channel through a midamble according to an exemplary embodiment of the present invention.

First, in order to acquire a report of channel measurement, the serving BS 200 transmits a channel measurement request message to the terminal 100 (S400). Here, the neighboring BSs 210 and 220 may transmit a channel measurement request message to the terminal 100 (S401). The channel measurement request message is shown in Table 1. As shown in Table 1, the channel measurement request message may include cell ID (IDcell) for measuring a physical channel, a location of a midamble to be transmitted, and a feedback type. The terminal 100 may measure a channel through such a channel measurement request message.

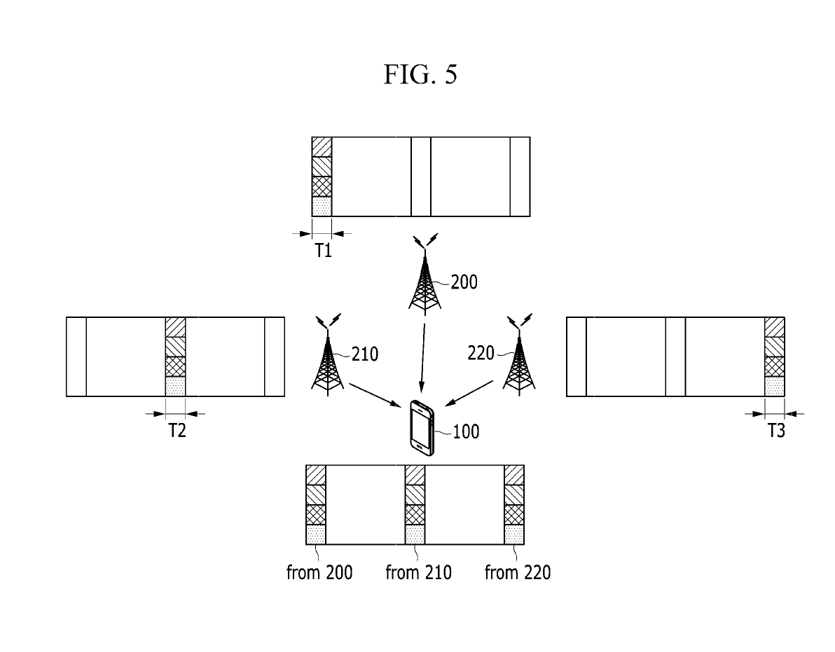

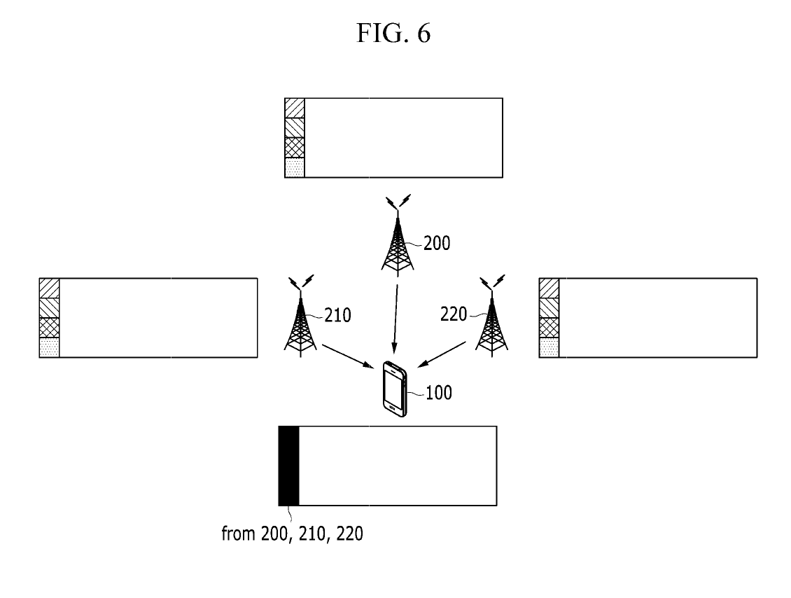

The BSs 200-220 that perform cooperative transmission transmit a signal for channel measurement (e.g., preamble, midamble, and pilot) in a specific area (S410 and S411). Hereinafter, for convenience of description, a case in which a signal for channel measurement is a midamble is exemplified, but other signals may be used. A method of transmitting a midamble will be described in detail in FIGS. 5 and 6.

The terminal 100 measures a channel state through a signal for channel measurement (S420). Here, a method in which the terminal 100 measures a channel is performed to correspond to information that is included in the channel measurement request message.

The terminal 100 reports information about a measured channel state to the serving BS 200 (S430). In this case, the terminal 100 may report information about a measured channel state to the neighboring BSs 210 and 220 (S431). A report of a measured channel state may be performed through a channel response message that is shown in Table 2. As shown in Table 2, the channel response message may include an ID cell, a measurement location of a channel, a measured value, and quality information about a channel (e.g., precoding applied to multiple antenna technology, and a Signal to Interference-plus-Noise Ratio (SINR), a Carrier to Interference-plus-Noise Ratio (CINR), and Received Signal Strength Indication (RSSI)) that are used for data allocation.

The serving BS 200 reports information about a channel state that it receives to the coordinator 300 (S440). The neighboring BSs 210 and 220 may report information about a channel state that they receive to the coordinator 300 (S441). Here, information about a channel state may be precoding that is applied to multiple antenna technology and a SINR, a CINR, and RSSI that are used for data allocation.

In a midamble that is used for channel measurement, the same midamble form may be transmitted through different resources, or a distinguishable midamble form may be transmitted.

FIG. 5 is a diagram illustrating a case in which a plurality of BSs transmit the same midamble at different time points. In FIG. 5, each slashed portion indicates a case in which BSs 200-220 include four antennas, and the BSs 200-220 each transmit four midamble signals.

As shown in FIG. 5, a plurality of BSs 200-220 each transmit a midamble of the same form to the terminal 100 at different time points. That is, the serving BS 200 transmits a midamble signal to the terminal 100 at a time point T1, the neighboring BS 210 transmits a midamble signal to the terminal 100 at a time point T2, and the neighboring BS 220 transmits a midamble signal to the terminal 100 at a time point T3. Here, a transmitting time point of a midamble is previously set by a channel measurement request message (particularly, a location of a midamble) that is described in the foregoing description. In this way, by transmitting a midamble at different time points, the BSs may reduce an identifier that distinguishes the midamble.

The terminal 100 may measure a channel state of each midamble using a midamble that is received at different time points. When transmitting a channel measurement request message (see S400 and S401 of FIG. 4), the BSs 200-220 may independently allocate a report area (channel) of the terminal 100 according to transmission of a corresponding midamble, and thus the terminal 100 may report channel state information that is measured through an allocated report area to a BS (a serving BS or a neighboring BS). A channel response message (see Table 2) of the terminal 100 may include an identifier (IDCell) that distinguishes an area that is measured by the terminal 100. The terminal 100 may select only information about a midamble appropriate for cooperative communication in a plurality of channel states that are measured through a plurality of midambles, and report the information to a corresponding BS. That is, in FIG. 5, the terminal 100 may report only a measurement channel state of some midambles of 12 received midambles to the serving BS 200.

The serving BS 200 or the neighboring BSs 210 and 220 report channel state information on a midamble basis to the coordinator 300. The coordinator 300 may select a transmission method of a BS that the coordinator 300 has based on received channel state information and notify the BS of a transmission method that the BS may use or a transmission method that the BS should not use. Each BS may select and apply a transmission method that can improve a service of a lower terminal based on information that is received from the coordinator, or may select and apply a transmission method of removing or reducing interference of a neighboring BS.

When cooperative transmission is performed without the control of the coordinator 300, the BSs 200-220 each independently select a transmission method based on a channel state on a midamble basis that is received from the terminal 100. Here, selection of a transmission method of a BS may be selection and application of a transmission method that can improve a service of a corresponding terminal or selection and application of a transmission method of removing or reducing interference of a neighboring BS.

FIG. 6 is a diagram illustrating a case in which a plurality of BSs transmit a midamble at the same time point.

As shown in FIG. 6, a plurality of BSs 200-220 transmit a midamble to the terminal 100 at the same time point. Here, each midamble includes information that distinguishes a midamble, and thus the terminal may distinguish midambles that are received from a plurality of BSs. Information that distinguishes a midamble may be a permutation identifier or a cell or BS identifier. When requesting channel measurement through a midamble (i.e., when transmitting a channel measurement request message), a plurality of BSs 200-220 may include a request for an input value necessary for channel measurement.

The terminal 100 measures a channel state of each midamble using a midamble that is distinguished by an identifier. The terminal 100 reports measured channel quality information to the BS (a serving BS or a neighboring BS) using an input value necessary for channel measurement. Similar to a case of FIG. 5, the terminal 100 may select only information about a midamble appropriate for cooperative communication among a plurality of channel states that are measured through a plurality of midambles and report the information to a corresponding BS.

The coordinator 300 may select a transmission method of a BS that the coordinator 300 has based on received channel state information, and the coordinator 300 may notify the BS of a transmission method that the BS may use or a transmission method that the BS should not use. Each BS may select and apply a transmission method that can improve a service of a lower terminal based on information that is received from the coordinator, or may select and apply a transmission method of removing or reducing interference of a neighboring BS.

When cooperative transmission is performed without the control of the coordinator 300, BSs 200-220 each independently select a transmission method based on a channel state on a midamble basis that is received from the terminal 100. Here, selection of a transmission method of a BS may be selection and application of a transmission method that can improve a service of a corresponding terminal or selection and application of a transmission method of removing or reducing interference of a neighboring BS.

Before performing cooperative transmission, the BS allocates and transmits data based on channel state information that is received from the terminal without help of a coordinator, thereby providing a service to the terminal. In this case, when the BS receives a request of a neighboring BS or a coordinator, the BS may transmit data through cooperative communication. A terminal belonging to the BS receives interference due to data that the neighboring BS transmits to the terminal, and thus when QoS is deteriorated, the BS may notify the neighboring BS or the coordinator of a corresponding fact. As a response thereto, cooperative transmission between BSs may be performed.

When the BS receives predetermined information for cooperative transmission from a coordinator, the BS may apply interference control based on the received information. In this case, a time point at which the BS applies interference control may be immediately after receiving related information or after a predetermined time period. Information about such a time point may be included in predetermined information for cooperative transmission.

Table 1 represents a format of a channel measurement request message, which is a message in which a BS requests measurement of a physical channel from a terminal. The message format may be an Interference Management_Cooperation Transmission-Channel Report Request (IM_CT-CH Report Request).

TABLE 1

| Name | Type | Length | Value |
|---|---|---|---|
| IDcell | 1.1 | 1 | Cell ID to measure the physical channel |
| Location of | 1.2 | 1 | OFDMA symbol offset to measure physical channel |
| Midamble | | | |
| Midamble physical | 1.3 | 1 | Midamble Physical CINR request is used with Channel Type |
| CINR request | | | Request = 0b01 (band AMC) to report CINR on the midamble. |
| | | | Bits 0-3: α_{avg} in multiples of 1/16 (range is [1/16, 16/16]). |
| | | | Bit 4: |
| | | | 0: Report only mean of CINR. |
| | | | 1: Report both mean and standard deviation of CINR. |
| | | | Bit 5-6 |
| | | | 0b00: report CINR assuming 1 stream |
| | | | 0b01: report CINR assuming 2 streams |
| | | | 0b10: report CINR using number of streams determined by |
| | | | MS |
| | | | 0b11: Reserved |
| | | | Bits 7: Reserved; shall be set to zero. |
| Feedback type | 1.4 | 1 | Feedback type to report of measured physical channel |
| | | | Bit 0: Recommended |
| | | | Bit 1: Restricted |
| | | | Bit 2-4: |
| | | | 0b000: MIMO coefficients feedback (for up to four antennas) |
| | | | 0b001: Long-term precoding feedback |
| | | | 0b010: Antenna grouping |
| | | | 0b011: Antenna selection |
| | | | 0b100: Quantized precoding weight feedback |
| | | | 0b101: Index to precoding matrix in codebook |
| | | | 0b110: Channel Matrix Information |
| | | | 0b111: Index to precoding matrix in codebook and Fast DL |
| | | | measurement |
| | | | Bit 5-7: Reserved |

Table 2 represents a format of a channel response message, which is a message in which a terminal responds with channel measurement to a BS. The message format may be an Interference Management_Cooperation Transmission-Channel Response (IM_CT-CH Report Response).

TABLE 2

| Name | Type | Length | Value |
|---|---|---|---|
| IDcell | 1.1 | 1 | Cell ID to report the measurement |
| Region ID | 1.2 | 1 | Region ID to report the measurement |
| The estimation of | 1.3 | 2 | The estimation of physical CINR measured from midamble. |
| physical CINR | | | Bit 15-Bit 8: mean |
| measured from | | | Bit 7-Bit 0: standard deviation |
| midamble in an | | | |
| STC zone with | | | |
| dedicated pilot | | | |
| MIMO feedback | 1.4 | 2 | CQI and MIMO feedback. The definition of MIMO feedback type (3 |
| type + feedback | | | bits) and the corresponding feedback payload (6 bits) for the enhanced |
| payload | | | fast-feedback channel. |
| | | | Bit 0-1: |
| | | | 0b00: Reserved |
| | | | 0b01: Recommended |
| | | | 0b10: Restricted |
| | | | 0b11: Reserved |
| | | | Bit 2-4: MIMO feedback type |
| | | | 0b000-0b010: Reserved |
| | | | 0b011: Quantized precoding weight feedback |
| | | | 0b100: Index to precoding matrix in codebook |
| | | | 0b101: Channel matrix Information |
| | | | 0b110: Index to precoding matrix in codebook and Fast DL |
| | | | measurement |
| | | | 0b111: Reserved |
| | | | Bit 5-Bit 10: Feedback payload |
| | | | Bit 11-Bit 15: Reserved |
| Number of index, L + | 1.5 | 2 | MIMO coefficients feedback for up to four antennas. |
| L occurrences of | | | Number of index, L (2 bits) + L occurrences of Antenna index (2 bits) + |
| Antenna index + | | | MIMO coefficients (5 bits) |
| MIMO coefficients | | | Bit 0-1: Number of index, L |
| | | | Bit 2-3: L occurrences of Antenna index |
| | | | Bit 4-5: |
| | | | 0b00: Reserved |
| | | | 0b01: Recommended |
| | | | 0b10: Restricted |
| | | | 0b11: Reserved |
| | | | Bit 6-Bit 11: MIMO coefficient |
| | | | Bit 12-Bit 15: Reserved |
| Long-term | 1.6 | 2 | Feedback of index to long-term precoding matrix in codebook (6 bits), |
| precoding feedback | | | rank of precoding codebook (2 bits) and FEC and QAM feedback (6 |
| | | | bits). |
| | | | Bit 0-1: |
| | | | 0b00: Reserved |
| | | | 0b01: Recommended |
| | | | 0b10: Restricted |
| | | | 0b11: Reserved |
| | | | Bit 2-7: Index to long-term precoding matrix element in codebook |
| | | | Bit 8-9: Rank of precoding codebook |
| | | | Bit 10-15: FEC and QAM feedback |
| Antenna grouping | 1.7 | 2 | Antenna grouping index (6 bits) + average CQI (5 bits) |
| feedback for CL | | | Bit 0-Bit 5: Antenna grouping index |
| MIMO | | | 0b101110~0b110110 in Table 8-337 |
| | | | Bit 6-Bit 10: average CQI |
| | | | Bit 11-Bit 15: Reserved |
| Antenna selection | 1.8 | 2 | Number of streams (2 bits) + Antennas selection option index (3 bits) + |
| feedback for CL | | | average CQI (5 bits) of the selected antennas |
| MIMO | | | Bit 0-Bit 1: Number of streams |
| | | | Bit 2-Bit 7: Antenna selection option index (6 bits) |
| | | | Bit 8-Bit 12: average CQI of the selection antennas |
| | | | Bit 13-Bit 15: Reserved |

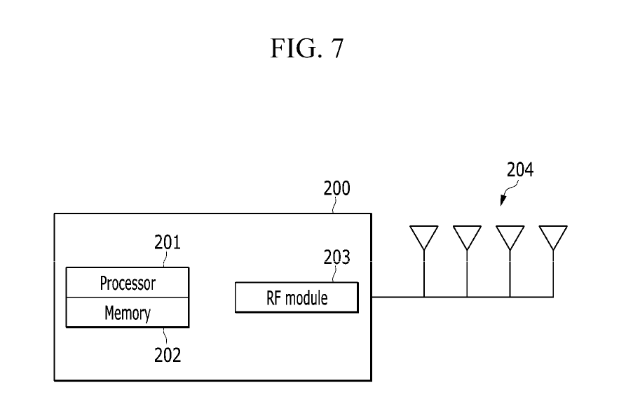

FIG. 7 is a diagram illustrating a serving BS 200 according to an exemplary embodiment of the present invention. FIG. 7 illustrates a case in which a BS is a serving BS, but the BS of FIG. 7 may be neighboring BSs 210 and 220.

As shown in FIG. 7, the serving BS 200 according to an exemplary embodiment of the present invention includes a processor 201, a memory 202, an RF module 203, and an antenna 204.

The processor 201 may be formed to implement a procedure, method, and function that are described with reference to FIGS. 2 to 6.

The memory 202 is connected to the processor 201 and stores various information that is related to operation of the processor 201.

The RF module 203 is connected to the antenna 204 and transmits or receives a wireless signal. The antenna 204 includes a multiple antenna (MIMO antenna), and the antenna 204 according to an exemplary embodiment of the present invention may perform cooperative communication by selectively using a multiple antenna.

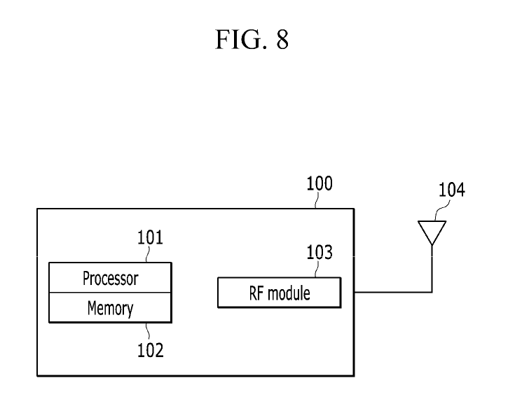

FIG. 8 is a diagram illustrating a terminal 100 according to an exemplary embodiment of the present invention.

As shown in FIG. 8, the terminal 100 according to an exemplary embodiment of the present invention includes a processor 101, a memory 102, an RF module 103, and an antenna 104.

The processor 101 may be formed to implement a procedure, method, and function that are described with reference to FIGS. 2 to 6.

The memory 102 is connected to the processor 101 and stores various information that is related to operation of the processor 101.

The RF module 103 is connected to the antenna 104 and transmits or receives a wireless signal. The antenna 104 includes a single antenna or a multiple antenna (MIMO antenna).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a terminal receives a service through cooperative communication between a first base station (BS) and a second BS, the method comprising:
receiving a first midamble from the first BS;
receiving a second midamble from the second BS;
measuring a channel through the first midamble and the second midamble; and
transmitting information about the measured channel to the first BS.

2. The method of claim 1, further comprising receiving a channel measurement request message, which is a message that requests measurement of the channel,
wherein the channel measurement request message comprises information about a location of the first midamble and the second midamble.

3. The method of claim 1, wherein the first midamble and the second midamble are received at different time points.

4. The method of claim 1, wherein the first midamble and the second midamble are received at the same time point and comprise different identifiers.

5. The method of claim 1, wherein the first and second midambles are each a plurality of midambles, and
the transmission of information about the measured channel comprises transmitting the information corresponding to some midambles of the plurality of midambles to the first BS.

6. The method of claim 1, further comprising transmitting the measured channel information to the second BS.

7. The method of claim 1, further comprising receiving downlink data from the first BS and the second BS.

8. The method of claim 1, wherein the first BS selects a transmission method of improving a service of the terminal, and the second BS selects a transmission method of reducing or removing interference to the first terminal.

9. The method of claim 2, wherein the channel measurement request message further comprises cell ID and a terminal feedback type.

10. A method in which a first base station (BS) provides a service to a terminal by cooperating with a second BS, the method comprising:
transmitting a channel estimation request message based on sounding to the terminal;
receiving a sounding signal from the terminal;
estimating a downlink channel by measuring the sounding signal; and
performing cooperative transmission with the terminal to correspond to the estimated downlink channel.

11. The method of claim 10, further comprising:
transmitting information about the estimated downlink channel to a coordinator;
receiving a request for the cooperative transmission from the coordinator; and
responding to the request from the coordinator.

12. The method of claim 10, wherein the channel estimation request message comprises information about a resource that is used for transmitting the sounding signal, and
the second BS uses the resource for overhearing the sounding signal.

13. The method of claim 12, wherein the second BS estimates a downlink channel by overhearing the sounding signal through the resource.

14. The method of claim 13, wherein the second BS performs cooperative transmission to the terminal to correspond to the estimated downlink channel.

15. The method of claim 13, wherein the second BS performs beamforming that reduces interference to the terminal or performs interference cancellation or interference nulling on the terminal to correspond to the estimated downlink channel.

16. A terminal that receives a service through cooperative communication between a plurality of base stations (BSs), the terminal comprising:
a radio frequency (RF) module that receives a plurality of midambles from the plurality of BSs; and
a processor that controls to measure a channel through the plurality of midambles and to transmit information about the measured channel to at least one of the plurality of BSs.

17. The terminal of claim 16, wherein the plurality of BSs comprise a first BS and a second BS, and
a first midamble that is received from the first BS and a second midamble that is received from the second BS are received at different time points.

18. The terminal of claim 16, wherein the processor controls to transmit the information corresponding to some midambles of the plurality of midambles to the at least one BS.

19. The terminal of claim 16, wherein the RF module receives a channel measurement request message, which is a message that requests measurement of the channel, and
the channel measurement request message comprises information about a location of the plurality of midambles signals.
